(19) United States
(12) Patent Application Publication
(10) Pub. No.: US 2008/0051576 A1
(43) Pub. Date: Feb. 28, 2008

(54) Pigment for charge generating layer in photoreceptive device

(75) Inventors: Francisco Lopez, Rochester, NY (US); Liang-bih Lin, Rochester, NY (US); Daniel Levy, Rochester, NY (US); Terry Bluhm, Pittsford, NY (US); Linda Ferrarese, Rochester, NY (US)

Correspondence Address: PILLSBURY WINTHROP SHAW PITTMAN, LLP;XEROX CORPORATION, P.O. BOX 10500, MCLEAN, VA, 22102, US

(73) Assignee: Xerox Corporation, Stamford, CT (US)

(21) Appl. No.: 11/508,651

(22) Filed: Aug. 23, 2006

(51) Int. Cl. G03G 5/047

(52) U.S. Cl. 540/140; 430/59.4

(57) ABSTRACT

Use of pigments for charge generating layers of imaging members. The pigments may include methoxygallium phthalocyanine. The pigments may have a sensitivity of between about 260 and about 290, and may include methoxygallium phthalocyanine that has been converted. The pigments may be used in a charge generating layer of an imaging member having a substrate, the charge generating layer, and a charge transfer layer.

### TECHNICAL FIELD

The present disclosure relates generally to imaging members, such as layered photoreceptor devices, and processes for making and using the same. The imaging members can be used in electrophotographic, electrostatographic, xerographic and like devices, including printers, copiers, scanners, facsimiles, and including digital, image-on-image, and like devices. More particularly, the embodiments pertain to an imaging member or a photoreceptor that incorporates specific materials, namely pigments such as alkoxygallium phthalocyanines, wherein the alkoxy is selected from the group of alkoxy having 1 to 10 carbon atoms such as methoxy, ethoxy, etc. (which include the pigment methoxygallium phthalocyanine), into the imaging member.

### BACKGROUND

Electrophotographic imaging members, e.g., photoreceptors, typically include a photoconductive layer formed on an electrically conductive substrate. The photoconductive layer is an insulator in the substantial absence of light so that electric charges are retained on its surface. Upon exposure to light, charge is generated by the photoactive pigment, and under applied field charge moves through the photoreceptor and the charge is dissipated.

In electrophotography, also known as xerography, electrophotographic imaging or electrostatographic imaging, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. Charge generated by the photoactive pigment move under the force of the applied field. The movement of the charge through the photoreceptor selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

An electrophotographic imaging member may be provided in a number of forms. For example, the imaging member may be a homogeneous layer of a single material such as vitreous selenium or it may be a composite layer containing a photoconductor and another material. In addition, the imaging member may be layered. These layers can be in any order, and sometimes can be combined in a single or mixed layer.

Typical multilayered photoreceptors have at least two layers, and may include a substrate, a conductive layer, an optional charge blocking layer, an optional adhesive layer, a photogenerating layer (sometimes referred to as, and used herein interchangeably, a “charge generation layer,” “charge generating layer,” or “charge generator layer”), a charge transport layer, an optional overcoating layer and, in some belt embodiments, an anticurl backing layer. In the multilayer configuration, the active layers of the photoreceptor are the charge generating layer (CGL) and the charge transport layer (CTL). Enhancement of charge transport across these layers provides better photoreceptor performance.

As more advanced, higher speed electrophotographic copiers, duplicators and printers were developed, however, degradation of image quality was encountered during extended cycling. The complex, highly sophisticated duplicating and printing systems operating at very high speeds have placed stringent requirements, including narrow operating limits, on the imaging members.

The majority of photoreceptor products use compounds in their CGLs that operate in a specific range of sensitivities of the imaging member. The sensitivity values are driven by the CGL and therefore are an indication of the performance of the CGL. The sensitivity is the rate of change of the surface voltage of the imaging member over the rate of change of the light energy exposed to the imaging member. Typically, sensitivity is described in units of Vcm²/ergs or Vcm²/μJ. For example, most photoreceptor products use either hydroxygallium phthalocyanine or chlorogallium phthalocyanine in the CGL. These pigments only operate in specific ranges of sensitivities, which are very far apart. For example, chlorogallium phthalocyanine has a sensitivity range from about 160 to about 190 Vcm²/ergs at a nominal device thickness of about 24 to about 28 μm, while hydroxygallium phthalocyanine has a sensitivity range from about 330 to about 370 Vcm²/ergs at a similar thickness range. However, some photoreceptor products require sensitivities that are in between these ranges. Because of this necessity, a compound for charge generating layers have been developed with a sensitivity range from about 250 to about 300 Vcm²/ergs at a device thickness of 24-28 μm has been developed through a mix of hydroxygallium phthalocyanine and bis-gallium phthalocyanil ethyl ether. The use of bis-gallium phthalocyanil ethyl ether, however, causes problems with coating quality due to issues with dispersion quality. In addition, the use of bis-gallium phthalocyanil ethyl ether in a CGL tends to cause increased dark decay, voltage depletion, and ghosting.

The term “electrostatographic” is generally used interchangeably with the term “electrophotographic.” In addition, the terms “charge blocking layer” and “blocking layer” are generally used interchangeably with the phrase “undercoat layer.”

### BRIEF SUMMARY

According to embodiments illustrated herein, there is provided a pigment for a charge generating layer that addresses the shortcomings discussed above.

An embodiment may include an imaging member comprising a substrate, a charge generating layer disposed on the substrate, the charge generating layer including a pigment comprising alkoxygallium phthalocyanine, wherein the alkoxy is selected from the group consisting of alkoxy moieties having 1 to 10 carbon atoms, and a binder; and a charge transport layer disposed on the charge generating layer.

In another embodiment, there is provided an imaging member comprising a substrate; a charge generating layer disposed on the substrate, the charge generating layer including a pigment comprising methoxygallium phthalocyanine, and a binder selected from the group consisting of polycarbonates, polyesters, polyvinyl chlorides, polysulfonates, copolymers of vinyl chloride and vinyl acetate, phenoxy resins, polyurethanes, poly(vinyl alcohol), polycrylonitrile, and polystyrene; and a charge transport layer disposed on the charge generating layer, wherein the methoxygallium phthalocyanine is a converted methoxygallium phthalocyanine that has been converted by a conversion process including mixing the methoxygallium phthalocyanine with dimethylformamide.

Another embodiment may include a product obtained by a process comprising dissolving bis-gallium phthalocyanil ethyl ether in sulfuric acid to form a first solution; dripping the first solution into a mixture of sodium methoxide and methanol, whereby a precipitate of methoxygallium phthalocyanine having a sensitivity of between about 190 and about 330 is formed; and filtering out the formed precipitate.

### BRIEF DESCRIPTION OF THE DRAWINGS

For a better understanding of the present embodiments, reference may be had to the accompanying figures.

FIG. 1 is a cross-sectional view of a multilayered electrophotographic imaging member according to an embodiment of the present disclosure.

FIG. 2 is a schematic nonstructural view showing an embodiment of the electrophotographic image forming apparatus of the present disclosure.

FIG. 3 is a graph of the charging curve of an embodiment of the present disclosure

FIG. 4 is a graph of the electrical scanning of an embodiment of the present disclosure.

FIG. 5 is a graph of nuclear magnetic resonance (NMR) spectrum of methoxygallium phthalocyanine dissolved in sulfuric acid in an embodiment of the present invention.

FIG. 6 is a graph of XRD (x-ray diffraction) spectrum of methoxygallium phthalocyanine obtained with a Siemens D5000 x-ray diffractometer, in an embodiment of the present invention.

### DETAILED DESCRIPTION

It is understood that other embodiments may be utilized and structural and operational changes may be made without departure from the scope of the embodiments disclosed herein.

The embodiments relate to an imaging member or photoreceptor that incorporates alkoxygallium phthalocyanine wherein alkoxy is selected from a group of alkoxy moiety having 1 to 10 carbon atoms such as methoxy- or ethoxy, for example, methoxygallium phthalocyanine to the formulation of a charge generating layer, which has improved sensitivity without creating issues with electrical characteristics or print quality.

According to embodiments herein, an electrophotographic imaging member is provided, which generally comprises at least a substrate layer, an imaging layer disposed on the substrate, and an optional overcoat layer disposed on the imaging layer. The imaging member includes, as imaging layers, a charge transport layer and a charge generating layer. The imaging member can be employed in the imaging process of electrophotography, where the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. The radiation selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

In a typical electrostatographic reproducing apparatus such as electrophotographic imaging system using a photoreceptor, a light image of an original to be copied is recorded in the form of an electrostatic latent image upon an imaging member and the latent image is subsequently rendered visible by the application of a developer mixture. The developer, having toner particles contained therein, is brought into contact with the electrostatic latent image to develop the image on an electrostatographic imaging member which has a charge-retentive surface. The developed toner image can then be transferred to a copy substrate, such as paper, that receives the image via a transfer member.

Alternatively, the developed image can be transferred to another intermediate transfer device, such as a belt or a drum, via the transfer member. The image can then be transferred to the paper by another transfer member. The toner particles may be transfixed or fused by heat and/or pressure to the paper. The final receiving medium is not limited to paper. It can be various substrates such as cloth, conducting or non-conducting sheets of polymer or metals. It can be in various forms, sheets or curved surfaces. After the toner has been transferred to the imaging member, it can then be transfixed by high pressure rollers or fusing component under heat and/or pressure.

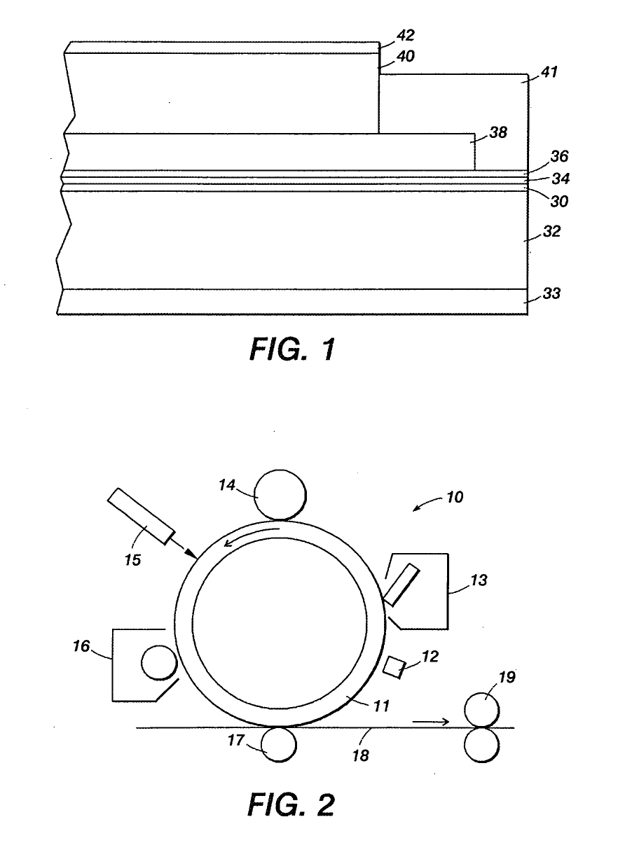

An embodiment of an imaging member is illustrated in FIG. 1. The substrate 32 has an optional electrical conductive layer 30. An optional undercoat layer 34 can also be applied over the conductive layer, as well as an optional adhesive layer 36 over the undercoat layer 34. The charge generating layer 38 is illustrated between an adhesive layer 36 and a charge transport layer 40. An optional ground strip layer 41 operatively connects the charge generating layer 38 and the charge transport layer 40 to the conductive layer 30. An anticurl back coating layer 33 may be applied to the side of the substrate 32 opposite from the electrically active layers to render desired imaging member flatness. Other layers of the imaging member may also include, for example, an optional overcoat layer 42 directly over the charge transport layer 40 to provide protection against abrasion and wear.

The conductive ground plane 30 over the substrate 32 is typically a thin, metallic layer, for example a 10 nanometer thick titanium coating, which may be deposited over the substrate by vacuum deposition or sputtering processes. The layers 34, 36, 38, 40 and 42 may be separately and sequentially deposited onto the surface of the conductive ground plane 30 of substrate 32 as wet coating layers of solutions comprising one or more solvents, with each layer being completely dried before deposition of the subsequent coating layer. The anticurl back coating layer 33 may also be solution coated, but is applied to the back side of substrate 32, to balance the curl and render imaging member flashes.

Illustrated herein are embodiments of an imaging member comprising a substrate, a charge generating layer disposed on the substrate, and at least one charge transport layer disposed on the charge generating layer. The charge generating layer comprises a phthalocyanine pigment. In certain embodiments the phthalocyanine pigment is methoxygallium phthalocyanine. In further embodiments, the phihalocyanine pigment of the charge generating layer is a single phthalocyanine pigment. For example, the pigment may consist essentially of methoxygallium phthalocyanine.

Illustrative examples of substrate layers selected for the imaging members may be opaque or substantially transparent, and may comprise any suitable material having the requisite mechanical properties. Thus, the substrate may comprise a layer of insulating material including inorganic or organic polymeric materials, such as MYLAR a commercially available polymer, MYLAR-containing titanium, a layer of an organic or inorganic material having a semiconductive surface layer, such as indium tin oxide, or aluminum arranged thereon, or a conductive material inclusive of aluminum, aluminized polyethylene terephthalate, titanized polyethylene chromium, nickel, brass or the like. The substrate may be flexible, seamless, or rigid, and may have a number of many different configurations, such as for example a plate, a cylindrical drum, a scroll, an endless flexible belt, and the like. In one embodiment, the substrate is in the form of a seamless flexible belt. The anticurl back coating is applied to the back of the substrate.

The thickness of the substrate layer depends on many factors, including economical considerations, thus this layer may be of substantial thickness, for example over 3,000 microns, or of minimum thickness providing there are no significant adverse effects on the member. In embodiments, the thickness of this layer is from about 75 microns to about 300 microns.

Moreover, the substrate may contain thereover an undercoat layer in some embodiments, including known undercoat layers, such as suitable phenolic resins, phenolic compounds, mixtures of phenolic resins and phenolic compounds, titanium oxide, silicon oxide mixtures like TiO₂/SiO₂.

In embodiments, the undercoat layer may also contain a binder component. Examples of the binder component include, but are not limited to, polyamides, vinyl chlorides, vinyl acetates, phenolic resins, polyurethanes, aminoplasts, melamine resins, benzoguanamine resins, polyimides, polyethylenes, polypropylenes, polycarbonates, polystyrenes, acrylics, styrene acrylic copolymers, methacrylics, vinylidene chlorides, polyvinyl acetals, epoxys, silicones, vinyl chloride-vinyl acetate copolymers, polyvinyl alcohols, polyesters, polyvinyl butyrals, nitrocelluloses, ethyl celluloses, caseins, gelatins, polyglutamic acids, starches, starch acetates, amino starches, polyacrylic acids, polyacrylamides, zirconium chelate compounds, titanyl chelate compounds, titanyl alkoxide compounds, organic titanyl compounds, silane coupling agents, and combinations thereof. In embodiments, the binder component comprises a member selected from the group consisting of phenolic-formaldehyde resin, melamine-formaldehyde resin, urea-formaldehyde resin, benzoguanamine-formaldehyde resin, glycoluril-formaldehyde resin, acrylic resin, styrene acrylic copolymer, and mixtures thereof.

In embodiments, the undercoat layer may contain an optional light scattering particle. In various embodiments, the light scattering particle has a refractive index different from the binder and has a number average particle size greater than about 0.8 μm. In various embodiments, the light scattering particle is amorphous silica P-100 commercially available from Espirit Chemical Co. In various embodiments, the light scattering particle is present in an amount of about 0% to about 10% by weight of a total weight of the undercoat layer.

In embodiments, the undercoat layer may contain various colorants. In various embodiments, the undercoat layer may contain organic pigments and organic dyes, including, but not limited to, azo pigments, quinoline pigments, perylene pigments, indigo pigments, thioindigo pigments, bisbenzimidazole pigments, phthalocyanine pigments, quinacridone pigments, quinoline pigments, lake pigments, azo lake pigments, anthraquinone pigments, oxazine pigments, dioxazine pigments, triphenylmethane pigments, azulenium dyes, squalium dyes, pyrylium dyes, triallylmethane dyes, xanthene dyes, thiazine dyes, and cyanine dyes. In various embodiments, the undercoat layer may include inorganic materials, such as amorphous silicon, amorphous selenium, tellurium, a selenium-tellurium alloy, cadmium sulfide, antimony sulfide, titanium oxide, tin oxide, zinc oxide, and zinc sulfide, and combinations thereof.

In embodiments, the thickness of the undercoat layer may be from about 0.1 μm to 30 μm.

A photoconductive imaging member herein can comprise in embodiments in sequence of a supporting substrate, an undercoat layer, an adhesive layer, a charge generating layer and a charge transport layer. For example, the adhesive layer can comprise a polyester with, for example, an M_{w} of about 70,000, and an Mₙ of about 35,000.

In embodiments, a photoconductive imaging member further includes an adhesive layer of a polyester with an M_{w} of about 75,000, and an Mₙ of about 40,000.

In embodiments, the charge generating layer (CGL) comprises a phthalocyanine pigment. In further embodiments, the phthalocyanine pigment is methoxygallium phthalocyanine. Although the phthalocyanine pigment is effective as the only pigment in the CGL, the phthalocyanine pigment may be used alone or in combination with another pigment, such as metal phthalocyanines, metal free phthalocyanines, perylenes, hydroxygallium phthalocyanines, chlorogallium phthalocyanines, titanyl phthalocyanines, vanadyl phthalocyanines, selenium, selenium alloys, trigonal selenium, and the like, and mixtures thereof.

In embodiments, the methoxygallium phthalocyanine is taken through a conversion process. The conversion process may improve the sensitivity of the methoxygallium phthalocyanine pigment to be higher than for the unconverted pigment. The conversion process involves mixing methoxygallium phthalocyanine with a solvent of dimethylformamide, acetates, ketones, or mixtures thereof or the like. In further embodiments, the converted methoxygallium phthalocyanine has a sensitivity of between about 190 and about 330 Vcm²/ergs, or may further have a sensitivity of between about 260 and about 290 Vcm²/ergs, where the imaging member has a thickness of between about 24 and about 28 μm.

In embodiments, the methoxygallium phthalocyanine is made by dissolving bis-gallium phthalocyanil ethyl ether in an acid, such as sulfuric acid. The solution is stirred and then slowly dripped into a mixture of sodium methoxide in methanol and excess methanol. The methoxygallium phthalocyanine formed is precipitated out of the sodium methoxide solution and may be filtered, for example using a glass fritted filter. The pigment may then be washed with methanol and/or deionized water until the conductivity of the filtrate reaches a desired amount, for example, below 10 microsiemens/cm (μS/cm). The pigment may then be dried out, for example in a vacuum oven. Once the methoxygallium phthalocyanine has been prepared, it may be milled, for example in an attritor with glass beads.

The pigment used for the charge generating layer, for example, methoxygallium phthalocyanine may be mixed with a binder. Photogenerating pigments can be selected for the charge generating layer in embodiments for example of an amount of from about 10 percent by weight to about 95 percent by weight dispersed in a binder. The pigment and binder may be mixed in a desired pigment:binder ratio, for example, about 60:40. Other ratios that can be used include anywhere in between 10:90 to 90:10 pigment to binder by weight. The solid content of the mixture may be about 12% but may also be anywhere from about 4% to about 12%. The binder may be a binder resin, such as any inactive resin material including those described, for example, in U.S. Pat. No. 3,121,006, the entire disclosure thereof being incorporated herein by reference. Typical organic resinous binders include thermoplastic and thermosetting resins such as one or more of polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polysamides, polyimides, amino resins, phenylene oxide resins, terephthalic acid resins, epoxy resins, phenolic reins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylacetate/vinylidene chloride copolymers, styrene-alkyd resins, and the like. An exemplary binder is a vinylchloride/vinyl acetate copolymer.

The pigment may be mixed with the binder in a solvent. It is desirable to select a coating solvent that does not substantially disturb or adversely affect the other previously coated layers of the device, such as ketones, alcohols, aromatic hydrocarbons, halogenated aliphatic hydrocarbons, ethers, amines, amides, esters, and the like. Specific examples are cyclohexanone, acetone, methyl ethyl ketone, methanol, ethanol, butanol, amyl alcohol, toluene, xylene, chlorobenzene, carbon tetrachloride, chloroform, methylene chloride, trichloroethylene, tetrahydrofuran, dioxane, diethyl ether, dimethyl formamide, dimethyl acetamide, butyl acetate, ethyl acetate, methoxyethyl acetate, and the like. An exemplary solvent is n-butyl acetate.

In further embodiments, the dried pigment is used in a conversion step. For example, the methoxygallium phthalocyanine may be mixed with dimethylformamide or another suitable conversion agent. This mixture may be rolled for a desired amount of time, f or example, 5 days at 60 rpm bottle speed. The pigment may then be collected and washed, for example with acetone. The washed pigment may then be dried overnight, for example, in a vacuum. The dried, washed pigment may then be milled, for example with 1-mm diameter glass beads.

Generally, the thickness of the charge generating layer depends on a number of factors, including the thicknesses of the other layers and the amount of photogenerator material or pigment contained in the charge generating layers. Accordingly, this layer can be of a thickness of, for example, from about 0.05 micron to about 5 microns, or from about 0.25 micron to about 2 microns when, for example, the pigments are present in an amount of from about 30 to about 75 percent by volume. The maximum thickness of this layer in embodiments is dependent primarily upon factors, such as photosensitivity, electrical properties and mechanical considerations. The charge generating layer binder resin present in various suitable amounts, for example from about 1 to about 50 or from about 1 to about 10 weight percent, may be selected from a number of known polymers, such as poly(vinyl butyral), poly(vinyl carbazole), polyesters, polycarbonates, poly(vinyl chloride), polyacrylates and methacrylates, copolymers of vinyl chloride and vinyl acetate, phenoxy resins, polyurethanes, poly(vinyl alcohol), polyacrylonitrile, polystyrene, and the like.

In embodiments, the charge transport layer includes a charge transport component and a binder. The charge transport layer may be between about 10 μm and about 50 μm in thickness. Examples of the binder materials selected for the charge transport layers include components, such as those described in U.S. Pat. No. 3,121,006, the disclosure of which is totally incorporated herein by reference. Specific examples of polymer binder materials include polycarbonates, polyarylates, acrylate polymers, vinyl polymers, cellulose polymers, polyesters, polysiloxanes, polyamides, polyurethanes, poly(cyclo olefins), and epoxies, and random or alternating copolymers thereof. In embodiments electrically inactive binders are comprised of polycarbonate resins with for example a molecular weight of from about 20,000 to about 100,000 and more specifically with a molecular weight M_{w} of from about 50,000 to about 100,000. Examples of polycarbonates are poly(4,4′-isopropylidene-diphenylene)carbonate (also referred to as bisphenol-A-polycarbonate, poly(4,4′-cyclohexylidinediphenylene) carbonate (referred to as bisphenol-Z polycarbonate), poly(4,4′-isopropylidene-3,3′-dimethyl-diphenyl)carbonate (also referred to as bisphenol-C-polycarbonate) and the like. In embodiments, the charge transport layer, such as a hole transport layer, may have a thickness from about 10 to about 55 microns. In embodiments, electrically inactive binders are selected comprised of polycarbonate resins having a molecular weight of from about 20,000 to about 100,000 or from about 50,000 to about 100,000. Generally, the transport layer contains from about 10 to about 75 percent by weight of the charge transport material or from about 35 percent to about 50 percent of this material.

In embodiments, the at least one charge transport layer comprises from about 1 to about 7 layers. For example, in embodiments, the at least one charge transport layer comprises a top charge transport layer and a bottom charge transport layer, wherein the bottom layer is situated between the charge generating layer and the top layer.

The charge transport layers can comprise in embodiments aryl amine molecules, and other known charge components. For example, a photoconductive imaging member disclosed herein may have charge transport aryl amines of the following formula:

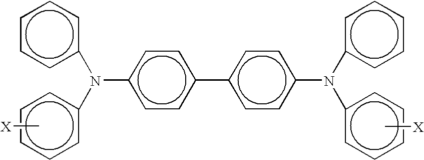

wherein x is alkyl, and wherein the aryl amine is dispersed in a resinous binder. In another embodiment, imaging member may have an aryl amine alkyl that is methyl, a halogen that is chloride, and a resinous binder selected from the group consisting of polycarbonates and polystyrene. In yet another embodiment, the photoconductive imaging member has an aryl amine that is N,N′-diphenyl-N,N-bis(3-methylphenyl)-1,1′-biphenyl-4,4′-diamine.

The charge transport aryl amines can also be of the following formula:

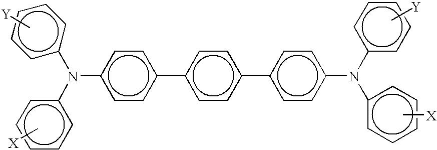

wherein X and Y are independently alkyl, alkoxy, aryl, a halogen, or mixtures thereof. Alkyl and alkoxy can contain for example from 1 to about 25 carbon atoms, and more specifically from 1 to about 12 carbon atoms, such as methyl, ethyl, propyl, butyl, pentyl, and the corresponding alkoxides. Aryl can contain from 6 to about 36 carbon atoms, such as phenyl, and the like. Halogen includes chloride, bromide, iodide and fluoride. Substituted alkyls, alkoxys, and aryls can also be selected in embodiments.

Examples of specific aryl amines include N,N′-diphenyl-N,N′-bis(alkylphenyl)-1,1-biphenyl-4,4′-diamine wherein alkyl is selected from the group consisting of methyl, ethyl, propyl, butyl, hexyl, and the like; N,N′-diphenyl-N,N′-bis(halophenyl)-1,1′-biphenyl-4,4′-diamine wherein the halo substituent is a chloro substituent; N,N′-bis(4-butylphenyl)-N,N′-di-p-tolyl-[p-terphenyl]-4,4″-diamine, N,N′-bis(4-butylphenyl)-N,N′-di-m-tolyl-[p-terphenyl]-4,4″-diamine, N,N′-bis(4-butylphenyl)-N,N′-di-o-tolyl-[p-terphenyl]-4,4″-diamine, N,N′-bis(4-butylphenyl)-N,N′-bis-(4-isopropylphenyl)-[p-terphenyl]-4,4″-diamine, N,N′-bis(4-butylphenyl)-N,N′-bis-(2-ethyl-6-methylphenyl)-[p-terphenyl]-4,4″-diamine, N,N′-bis(4-butylphenyl)-N,N′-bis-(2,5-dimethylphenyl)-[p-terphenyl]-4,4″-diamine, N,N′-diphenyl-N,N′-bis(3-chlorophenyl)-[p-terphenyl]-4,4″-diamine and the like and optionally mixtures thereof. Other known charge transport layer molecules can be selected, reference for example, U.S. Pat. Nos. 4,921,773 and 4,464,450, the disclosures of which are totally incorporated herein by reference. In embodiments, the charge transport layer may comprise aryl amine mixtures.

An adhesive layer may optionally be applied such as to the undercoat layer. The adhesive layer may comprise any suitable material, for example, any suitable film forming polymer. Typical adhesive layer materials include for example, but are not limited to, copolyester resins, polyarylates, polyurethanes, blends of resins, and the like. Any suitable solvent may be selected in embodiments to form an adhesive layer coating solution. Typical solvents include, but are not limited to, for example, tetrahydrofuran, toluene, hexane, cyclohexane, cyclohexanone, methylene chloride, 1,1,2-trichloroethane, monochlorobenzene, and mixtures thereof, and the like.

In embodiments, the at least one charge transport layer comprises an antioxidant optionally comprised of, for example, a hindered phenol or a hindered amine.

Also, included herein are methods of imaging and printing with the photoresponsive devices illustrated herein. These methods generally involve the formation of an electrostatic latent image on the imaging member, followed by developing the image with a toner composition comprised, for example, of thermoplastic resin, colorant, such as pigment, charge additive, and surface additives, reference U.S. Pat. Nos. 4,560,635; 4,298,697 and 4,338,390, the disclosures of which are totally incorporated herein by reference, subsequently transferring the image to a suitable substrate, and permanently affixing the image thereto. In those environments wherein the device is to be used in a printing mode, the imaging method involves the same steps with the exception that the exposure step can be accomplished with a laser device or image bar.

When an imaging member of the present disclosure is used, prints made with the imaging member exhibits substantially no ghosting. Additionally, the dark decay of the pigment is less than about 100 volts/s.

FIG. 2 shows a schematic constitution of an embodiment of an image forming apparatus 10. The image forming apparatus 10 is equipped with an imaging member 11, such as a cylindrical photoreceptor drum, having a charge retentive surface to receive an electrostatic latent image thereon. Around the imaging member 11 may be disposed a static eliminating light source 12 for eliminating residual electrostatic charges on the imaging member 11, an optional cleaning blade 13 for removing the toner remained on the imaging member 11, a charging component 14, such as a charger roll, for charging the imaging member 11, a light-exposure laser optical system 15 for exposing the imaging member 11 based on an image signal, a development component 16 to apply developer material to the charge-retentive surface to create a developed image in the imaging member 11, and a transfer component 17, such as a transfer roll, to transferring a toner image from the imaging member 11 onto a copy substrate 18, such as paper, in this order. Also, the image forming apparatus 10 is equipped with a fusing component 19, such as a fuser/fixing roll, to fuse the toner image transferred onto the copy substrate 18 from the transfer component 17.

The light exposure laser optical system 15 is equipped with a laser diode (for example, oscillation wavelength 780 nm) for irradiating a laser light based on an image signal subjected to a digital treatment, a polygon mirror polarizing the irradiated laser light, and a lens system of moving the laser light at a uniform velocity with a definite size.

Various exemplary embodiments encompassed herein include a method of imaging which includes generating an electrostatic latent image on an imaging member, developing a latent image, and transferring the developed electrostatic image to a suitable substrate.

In a selected embodiment, an image forming apparatus for forming images on a recording medium comprising: a) an imaging member having a charge retentive- surface for receiving an electrostatic latent image thereon, wherein the imaging member comprises a substrate, a charge generating layer disposed on the substrate, and at least one charge transport layer disposed on the charge generating layer; b) a development component for applying a developer material to the charge-retentive surface to develop the electrostatic latent image to form a developed image on the charge-retentive surface; c) a transfer component for transferring the developed image from the charge-retentive surface to a copy substrate; and d) a fusing component for fusing the developed image to the copy substrate.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Preparation of Pigment for Charge Generating Layer

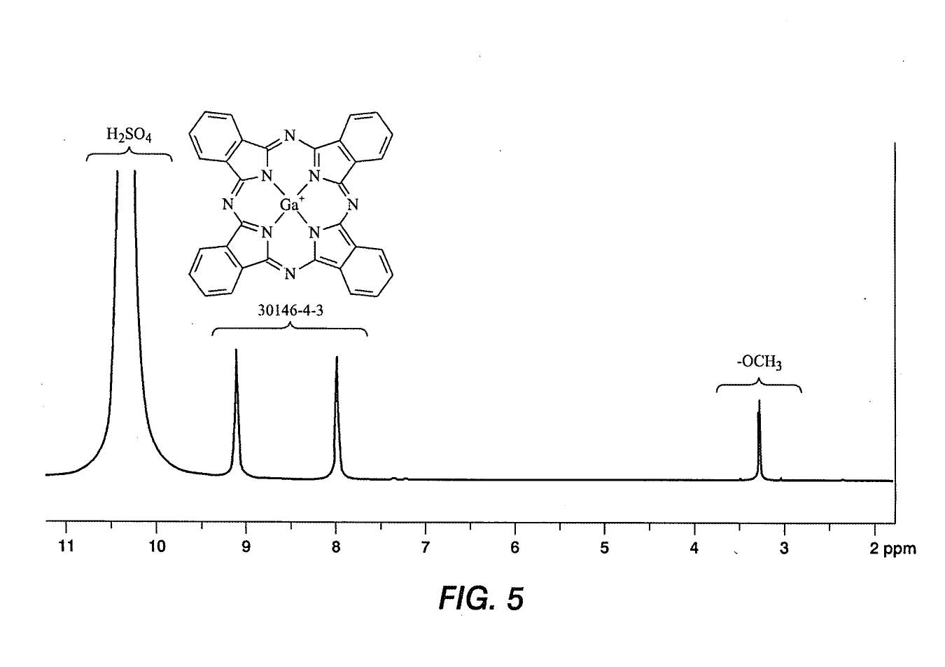

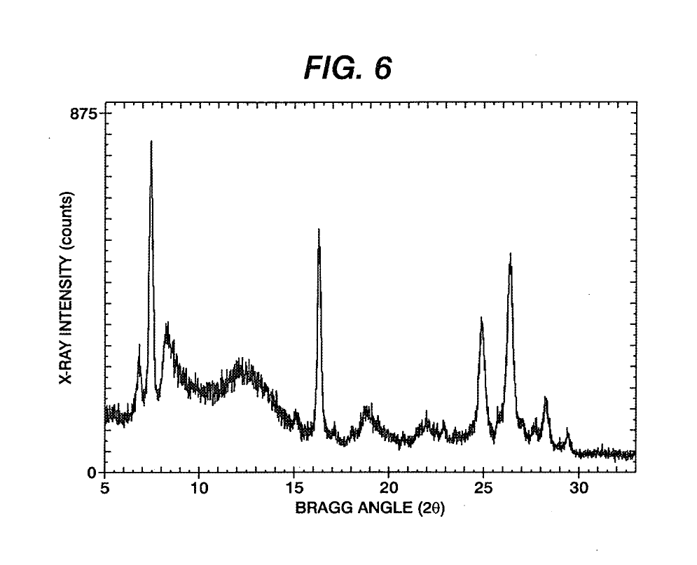

9 grams of alkoxygallium phthalocyanine was dissolved in 270 grams of sulfuric acid. This solution was allowed to stir for 2 hours at 60° C. The pigment solution was then slowly dripped into a mixture of 1082.7 grams of sodium methoxide in methanol and 225 grams of excess methanol. The methoxygallium phthalocyanine precipitated out of the sodium methoxide solution. This precipitate was filtered out using a 4-8 μm glass fritted filter. The pigment was washed once with methanol and then deionized water until the conductivity of the filtrate measured below 10 microsiemens/cm (μS/cm). The pigment was dried overnight in a vacuum oven. The dried methoxygallium phthalocyanine was submitted for X-ray diffraction (XRD) analysis. X-Ray Powder Diffraction Patterns were collected using a Siemens D5000 X-Ray Powder Diffractometer equipped with an proportional counter fitted with pulse-height discrimination and operated at 40 kilovolts and 30 microamperes. Copper K alpha radiation (Lambda=0.15418 nanometer wavelength) was used. XRPD patterns were collected from powder samples in step scanning mode using a step size of 0.05 degrees two-theta and a counting time of 10 seconds per step. FIG. 6 shows a graph of the XRD scan obtained. The XRD scan showed that there are major diffraction peaks at Bragg angles 6.9, 7.5, 8.4, 16.4, 25.0, 26.4, and 28.3 degrees 2θ (2 theta±0.2°). The methoxygallium phthalocyanine was also dissolved in sulfuric acid and submitted for nuclear magnetic resonance (NMR) analysis. NMR analysis also confirmed the presence of methoxygallium phthalocyanine, as shown in FIG. 5. A chemical shift of 3.25 ppm and chemical shifts of 7.9 and 9.2 ppm corresponding to methoxy and gallium phthalocyanine moieties, respectively in the proton NMR spectrum, confirmed the presence of methoxygallium phthalocyanine.

The dried pigment was milled in an attritor with HiBea brand D20 1-mm diameter glass beads available from Ohara. The dispersion had a pigment to binder ratio of 60:40 at 12% solid content. The binder was vinyl chloride/vinyl acetate (VCMH) and the solvent was n-butyl acetate. The final coating dispersion was letdown to 5%. The dispersion was coated on rough lathed substrates with an organozirconinum based undercoat layer. The dispersion was coated at 150 mm/min. An arylamine charge transfer layer was dip coated at 13 μm and 25 μm thickness. The drums were submitted for electrical scanning.

The dried pigment was also used in the following conversion step. In a 120-ml amber glass bottle, 4 grams of the methoxygallium phthalocyanine pigment was mixed with 40 grams of dimethylformamide and 133 grams of HiBea D20 1-mm diameter glass beads. This was allowed to roll for 5 days at 60-rpm bottle speed. The pigment was collected using a 4-8 μm glass fritted filter. The pigment was washed with generous portions of acetone prior to drying in a vacuum oven overnight. The methoxygallium phthalocyanine was then milled in an attritor as described above with HiBea D20 1-mm diameter glass beads. The dispersion coating was also completed as described above. The drums were submitted for electrical scanning and print testing. TABLE 1 shows the electrical characteristics of the methoxygallium phthalocyanine produced in this example and of the Tunable multiple pigment charge generating layer, which consists of a mixture of hydroxygallium phthalocyanine and chlorogallium phthalocyanine. The dispersion is made with the binder vinyl chloride/vinyl acetate (VCMH) and the solvent n-butyl acetate. As shown in TABLE 1, the sensitivity −dV/dx was much higher for the converted pigment that the unconverted pigment. The column of V depletion indicates the amount of voltage applied to the photoreceptor before it actually begins to keep a charge. In other words, the photoreceptor shown in the first row had 58.7 volts applied to its surface before the photoreceptor stopped discharging it in the dark. V erase is the surface voltage left on the photoreceptor after it has been exposed to an erase lamp. The erase lamp is applied to the photoreceptor so that it discharges as much as possible and erases any latent images. The dark decay is the voltage loss on the photoreceptor surface after it has been charged. This loss occurs in the dark and is due to the photoreceptor's charge generation layer producing charges in the dark. The number in the parenthesis indicates the ergs/cm² applied.

TABLE 1

| | | | | | | dark | | | | | |
|---|---|---|---|---|---|---|---|---|---|---|---|
| | | Thickness | V | | Verase | decay | | | | | |
| Description | −dV/dx | (μm) | depletion | DDR@100 nC | (V) | (V) | V(1) | V(2) | V(3) | V(4) | V(9) |
| methoxygallium | 48.9 | 10.2 | 58.7 | 142.5 | 33.5 | 107.5 | 651.2 | 604.0 | 555.4 | 507.1 | 331.0 |
| phthalocyanine at 150 mm/min, | | | | | | | | | | | |
| 13 μm charge | | | | | | | | | | | |
| transfer layer | | | | | | | | | | | |
| methoxygallium | 52.3 | 9.9 | 63.0 | 182.8 | 41.5 | 123.8 | 649.4 | 596.6 | 545.8 | 497.8 | 296.3 |
| phthalocyanine at 200 mm/min, | | | | | | | | | | | |
| 13 μm charge | | | | | | | | | | | |
| transfer layer | | | | | | | | | | | |
| methoxygallium | 66.3 | 23.7 | 14.9 | 239.5 | 41.6 | 40.0 | 636.0 | 575.4 | 519.0 | 467.4 | 276.0 |
| phthalocyanine at 150 mm/min, | | | | | | | | | | | |
| 25 μm charge | | | | | | | | | | | |
| transfer layer | | | | | | | | | | | |
| methoxygallium | 71.2 | 23.1 | 15.0 | 336.3 | 42.4 | 29.6 | 631.1 | 566.4 | 505.0 | 449.3 | 247.6 |
| phthalocyanine at 200 mm/min, | | | | | | | | | | | |
| 25 μm charge | | | | | | | | | | | |
| transfer layer | | | | | | | | | | | |
| converted methoxygallium | 186.7 | 12.9 | 14.6 | 77.3 | 13.0 | 12.0 | 523.3 | 365.8 | 234.3 | 130.9 | 23.7 |
| phthalocyanine at 150 mm/min, | | | | | | | | | | | |
| 13 μm charge | | | | | | | | | | | |
| transfer layer | | | | | | | | | | | |
| converted methoxygallium | 192.1 | 12.9 | 12.5 | 59.9 | 15.4 | 12.1 | 518.0 | 357.6 | 223.2 | 120.4 | 26.1 |
| phthalocyanine at 200 mm/min, | | | | | | | | | | | |
| 13 μm charge | | | | | | | | | | | |
| transfer layer | | | | | | | | | | | |
| converted methoxygallium | 272.4 | 24.9 | 29.2 | 96.0 | 29.6 | 11.0 | 450.7 | 249.3 | 113.9 | 60.8 | 39.7 |
| phthalocyanine at 150 mm/min, | | | | | | | | | | | |
| 25 μm charge | | | | | | | | | | | |
| transfer layer | | | | | | | | | | | |
| converted methoxygallium | 292.6 | 24.9 | 33.1 | −5.4 | 31.1 | 10.9 | 432.5 | 219.8 | 90.5 | 52.9 | 39.5 |
| phthalocyanine at 200 mm/min, | | | | | | | | | | | |
| 25 μm charge | | | | | | | | | | | |
| transfer layer | | | | | | | | | | | |
| 3C/Tunable 170, 25 μm | 303.66 | 24.9 | 79.4 | 92.5 | 39.1 | 12.0 | 404.1 | 174.0 | 78.8 | 78.8 | 48.8 |
| charge transfer layer | | | | | | | | | | | |
| 3C/Tunable 240, 25 μm | 335.23 | 24.9 | 108.3 | 481.5 | 39.7 | 17.0 | 379.7 | 147.7 | 69.3 | 69.3 | 48.8 |
| charge transfer layer | | | | | | | | | | | |

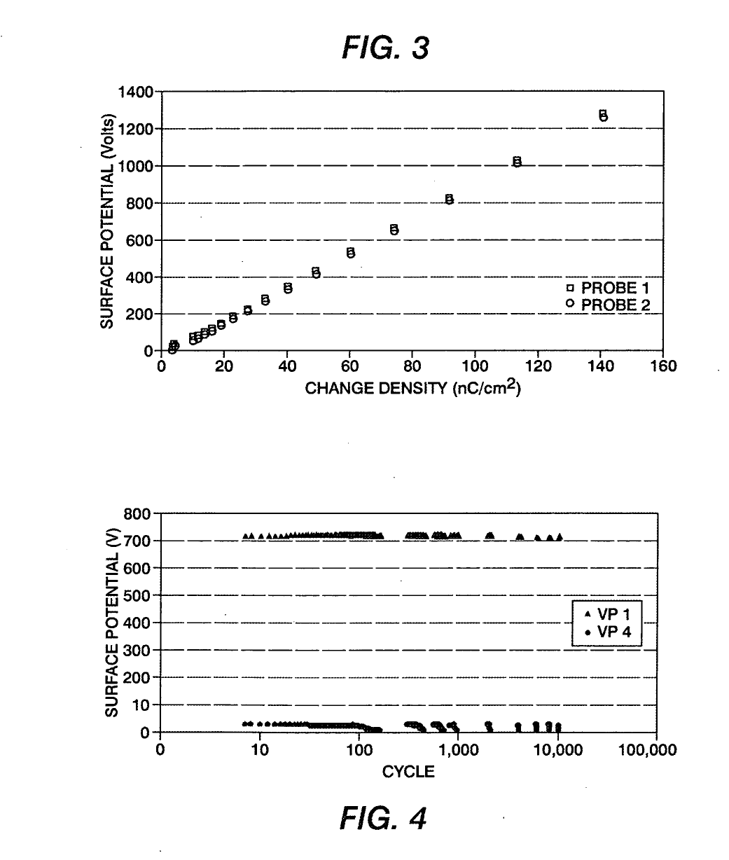

The above data in Table 1 shows that the converted methoxygallium phthalocyanine pigment provides almost the same sensitivity as the Tunable charge generating layer sample. In addition to the comparable sensitivity, the methoxygallium phthalocyanine has lower dark decay and voltage depletion than the Tunable charge generating layer. FIG. 3 shows the charging curve for methoxygallium phthalocyanine at 200 mm/min and 25 μm charge transfer layer. The straight-line trend of the curve demonstrates the good charging characteristics of the sample and the lack of any breakdown. Also in FIG. 3 is the charging at the second probe. The small difference between the two probes (time difference of 215 msec between probes) further indicates the low dark decay in the sample.

The methoxygallium phthalocyanine also demonstrates stable charging and discharging in short cycling tests. FIG. 4 shows the results for 10-kycycle electrical scanning of the methoxygallium phthalocyanine sample coated at 200 mm/min with a 25 μm charge transfer layer. There is no cycle down in the charging (shown in VP1 in FIG. 4, where VP1 is the surface potential of the imaging member measured) and there is no cycle up in the discharging (shown in VP4 in FIG. 4) of the device through the 10,000 cycles.

The print test data in Table 2 shows that there is no ghosting for the methoxygallium phthalocyanine samples and a low background level as well. At 25 μm charge transfer layer thickness, the print is almost clear to obtain a level that is just above the lowest level of 1. At 13 μm charge transfer layer thickness the level is slightly higher at 3, but is still low. The 13 μm charge transport layer simulates the end of the life of the photoreceptor. This low background value of 3 indicates that the photoreceptor will behave very well at the end of its life.

TABLE 2

| Description | Background | Ghosting |
|---|---|---|
| Converted Pc8 at 150 mm/min, 13 um | 3 | 0 |
| Converted Pc8 at 200 mm/min, 13 um | 3 | 0 |
| Converted Pc8 at 150 mm/min, 25 um | 1+ | 0 |
| Converted Pc8 at 200 mm/min, 25 um | 1+ | 0 |
| 3 C/Tunable 170, 25 um | na | 1 |
| 3 C/Tunable 240, 25 um | na | 3 |

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An imaging member comprising:
a substrate;
a charge generating layer disposed on the substrate, the charge generating layer including:
a pigment comprising alkoxygallium phthalocyanine, wherein the alkoxy is selected from the group consisting of alkoxy moieties having 1 to 10 carbon atoms and
a binder; and
a charge transport layer disposed on the charge generating layer.

2. The imaging member of claim 1, wherein the alkoxygallium phthalocyanine is methoxygallium phthalocyanine.

3. The imaging member of claim 2, wherein the pigment consist essentially of methoxygallium phthalocyanine.

4. The imaging member of claim 2, wherein the methoxygallium phthalocyanine is a converted methoxygallium phthalocyanine.

5. The imaging member of claim 4, wherein the converted methoxygallium phthalocyanine has been converted through a conversion process including mixing the methoxygallium phthalocyanine with dimethylformamide.

6. The imaging member of claim 1, wherein the imaging member has a thickness of between about 24 and about 28 μm and a sensitivity of between about 190 and about 330 Vcm²/ergs.

7. The imaging member of claim 4, wherein the pigment has a sensitivity of between about 260 and about 290 Vcm²/ergs.

8. The imaging member of claim 1, wherein the binder is selected from the group consisting of polycarbonates, polyesters, polyvinyl chlorides, polysulfonates, copolymers of vinyl chloride and vinyl acetate, phenoxy resins, polyurethanes, poly(vinyl alcohol), polyacrylonitrile, and polystyrene.

9. The imaging member of claim 6, wherein the binder is a vinyl chloride/vinyl acetate copolymer.

10. The imaging member of claim 1, wherein the charge generating layer is between about 0.05 μm and about 5 μm in thickness.

11. The imaging member of claim 10, wherein the charge generating layer is between about 0.25 μm and about 2 μm in thickness.

12. The imaging member of claim 1, wherein the charge transport layer is between about 10 μm and about 50 μm in thickness.

13. An imaging member comprising:
a substrate;
a charge generating layer disposed on the substrate, the charge generating layer including:
a pigment comprising methoxygallium phthalocyanine, and
a binder selected from the group consisting of polycarbonates, polyesters, polyvinyl chlorides, polysulfonates, copolymers of vinyl chloride and vinyl acetate, phenoxy resins, polyurethanes, poly(vinyl alcohol), polyacrylonitrile, and polystyrene; and
a charge transport layer disposed on the charge generating layer, wherein the methoxygallium phthalocyanine is a converted methoxygallium phthalocyanine that has been converted by a conversion process including mixing the methoxygallium phthalocyanine with dimethylformamide.

14. A product obtained by a process comprising:
dissolving bis-gallium phthalocyanil ethyl ether in sulfuric acid to form a first solution;
dripping the first solution into a mixture of sodium methoxide and methanol, whereby a precipitate of methoxygallium phthalocyanine formed; and
filtering out the formed precipitate.

15. The product of claim 15, wherein the precipitate consists essentially of methoxygallium phthalocyanine.

16. The product of claim 15, wherein the process further comprises converting the precipitate through a conversion process including mixing the pigment with dimethylformamide.

17. The product of claim 18, wherein the process further includes washing the mixed pigment and dimethylformamide with acetone and drying the washed mixture.
